(19) United States
(12) Patent Application Publication
(10) Pub. No.: US 2018/0098130 A1
(43) Pub. Date: Apr. 5, 2018

(54) MULTI-DISPLAY CONTROL APPARATUS

(71) Applicant: QUOPIN CO., LTD., Seongnam-si (KR)

(72) Inventor: Hack Kyung KIM, Incheon (KR)

(73) Assignee: QUOPIN CO., LTD., Seongnam-si (KR)

(21) Appl. No.: 15/719,941

(22) Filed: Sep. 29, 2017

(30) Foreign Application Priority Data
Sep. 30, 2016 (KR) 10-2016-0126762

(51) Int. Cl. H04N 21/61; H04N 21/44; H04N 21/442; H04N 21/4402; H04N 21/41; H04N 21/4363; H04N 21/6373

(52) U.S. Cl. CPC H04N 21/615; H04N 21/44004; H04N 21/4424; H04N 21/440281; H04N 21/6373; H04N 21/4122; H04N 21/43632; H04N 21/43637; H04N 21/6118

(57) ABSTRACT

Disclosed is a multi-display control apparatus including: a broadcast signal splitter connected to a cable, which is a medium for receiving broadcast content, and configured to duplicate a broadcast signal received through the cable into first and second broadcast signals and immediately provide the first broadcast signal to a first display device; a buffer configured to buffer the second broadcast signal; a transmitter configured to perform digital encoding of the duplicated second broadcast signal based on a state of transmission to a second display device, and transmit the encoded data over Ethernet or Wi-Fi; a broadcast signal provision unit configured to receive and decode the encoded data, and provide the decoded data as an input to the second display device.

### CROSS-REFERENCE TO RELATED APPLICATIONS

A claim for priority under 35 U.S.C. § 119 is made to Korean Patent Application No. 10-2016-0126762 filed Sep. 30, 2016, in the Korean Intellectual Property Office, the entire contents of which are hereby incorporated by reference.

### BACKGROUND OF THE INVENTION

### Field of the invention

The present disclosure relates to a multi-display control technology, and more particularly to a multi-display control apparatus capable of efficiently providing broadcast signals to multiple displays.

### Related Art

As various types of content are now able to be provided on a display and traditional outdoor advertising posters are replaced by digital signage (DS), numerous services have been introduced. The digital signage industry is a representative field of smart media and regarded a promising field because it is expected to become the “fourth screen” after TV, PC, and mobile devices.

For digital signage, a multi-display control technology is required. Yet, an existing multi-display control technology needs an additional set top box or a complex control apparatus to transmit a broadcast signal to each of multiple displays.

Korean Patent Application Publication No. 10-2016-0021286 relates to an apparatus for transmitting broadcast signals, an apparatus for receiving broadcast signals, and a method for transmitting broadcast signals, and a method for receiving broadcast signals, and includes: a delivery object generator configured to divide a file into at least one delivery object corresponding to a part of the file; a signaling encoder configured to encode signaling information including metadata for the delivery object, the signaling information including real time information indicating whether the at least one delivery object is transmitted in real time via a unidirectional channel using at least one layered coding transport (LCT) packet; and a transmitter configured to transmit the at least one delivery object and the signaling information.

Korean Patent No. 10-1659955 relates to a multi-display device and a method of controlling the same by variably control the power supply of a plurality of displays included in the multi-display device according to at least one criterion so as to control an output state of the plurality of displays.

This work was supported by Institute for Information & communications Technology Promotion(IITP) grant funded by the Korea government(MSIT)(No. 2017-0-00794, Wireless Module Developments for wireless transmission of Virtual Reality contents)

### SUMMARY OF THE INVENTION

In one embodiment of the present disclosure, there is provided a multi-display control apparatus capable of efficiently providing broadcast signals to multiple displays.

In one embodiment of the present disclosure, there is provided a multi-display control apparatus capable of being simply connected to cable input terminals of multiple displays and immediately providing a broadcast signal, received from a set top box, to each of the multiple displays or selectively processing and transmitting the broadcast signal.

In one embodiment of the present disclosure, there is provided a multi-display control apparatus capable of duplicating a broadcast signal received through a cable, immediately providing the duplicated broadcast signal as a wired input to a first display device, and transmitting the duplicated broadcast signal to a second display device by performing digital encoding of the duplicated broadcast signal based on a transmission state.

In one embodiment of the present disclosure, there is provided a multi-display control apparatus capable of controlling a quality of a broadcast signal and a degree of buffering of the broadcast signal based on a transmission state in the process of transmitting the broadcast signal to multiple displays.

In one general aspect, the multi-display control apparatus including: a broadcast signal splitter connected to a cable, which is a medium for receiving broadcast content, and configured to duplicate a broadcast signal received through the cable into first and second broadcast signals and immediately provide the first broadcast signal to a first display device; a buffer configured to buffer the second broadcast signal; a transmitter configured to perform digital encoding of the duplicated second broadcast signal based on a state of transmission to a second display device, and transmit the encoded data over Ethernet or Wi-Fi; a broadcast signal provision unit configured to receive and decode the encoded data, and provide the decoded data as an input to the second display device.

The broadcast signal splitter may receive the broadcast signal through the cable drawn from a set top box, and be connected to a cable input terminal of the first display device.

The broadcast signal splitter may include an integrated port switch that enables accommodation of the cable from a first direction, connection to an input terminal of the first display device, and wired connection to an input terminal of the broadcast signal provision unit in a second direction.

The integrated port switch may include: a male screw thread for accommodation of the cable; a female screw thread for connection to an input terminal of the first display device; and a cable output terminal for wired connection to the input terminal of the broadcast signal provision unit.

The broadcast signal provision unit may detect a delay tolerance set in the second display device and determine a degree of buffering of the second broadcast signal.

When the delay tolerance is close to real-time playback and the transmission state is equal to or less than a specific level, the broadcast signal provision unit may reduce a quality of the second broadcast signal to a minimum

The broadcast provision unit may recover the quality of the second broadcast signal in stages whenever the transmission state of is recovered.

When the delay tolerance is close to non-real-time playback and the transmission state is equal to or less than a specific level, the broadcast signal provision unit may set the degree of buffering to a maximum allowable buffering for the second display device.

When the transmission state is equal or less than the specific level even after adjustment of the degree of buffering, the broadcast signal provision unit may reduce a quality of the second broadcast signal to a minimum

The second display apparatus may correspond to a digital signage device that embeds broadcast content based on the second broadcast signal.

The present disclosure may have the following effects. However, it does not mean that a specific embodiment have all of the following effects or only them, and thus, that the scope of claims of the present disclosure is not limited thereto.

A multi-display control apparatus according to an embodiment of the present disclosure may efficiently provide broadcast signals to multiple displays.

A multi-display control apparatus according to an embodiment of the present disclosure may be simply connected to cable input terminals of multiple displays and may immediately provide a broadcast signal, received from a set top box, to each of the multiple displays or selectively processing and then transmitting the broadcast signal to each of the multiple.

A multi-display control apparatus according to an embodiment of the present disclosure may duplicate a broadcast signal, received through a cable and immediately provide the duplicated broadcast signal as a wired input to a first display device or transmitting the duplicated broadcast signal to a second display device by performing digital encoding of the duplicated broadcast signal.

A multi-display control apparatus according to an embodiment of the present disclosure may control a quality of a broadcast signal and a degree of buffering of the broadcast signal based on a transmission state in the process of transmitting the broadcast signal to multiple displays.

### BRIEF DESCRIPTION OF THE DRAWINGS

FIG. 1 is a diagram illustrating a multi-display control system according to an embodiment of the present disclosure.

FIG. 2 is a diagram illustrating the multi-display control device shown in FIG. 1.

FIG. 3 is a flowchart illustrating how the multi-display control apparatus shown in FIG. 1 controls transmitting of broadcast content to a plurality of displays.

### DESCRIPTION OF EXEMPLARY EMBODIMENTS

A description of the present disclosure is merely an embodiment for a structural and/or functional description. The range of right of the present disclosure should not be construed as being limited to embodiments described in the context. That is, the embodiments may be modified in various forms, and the range of right of the present disclosure should be construed as including equivalents which may realize the technological spirit. Furthermore, an object or effect proposed in the present disclosure does not mean that a specific embodiment should include all of objects or effects or should include a corresponding effect, and thus the range of right of the present disclosure should not be understood to be restricted thereby.

The meaning of terms described in this application should be construed as follows.

The terms, such as the “first” and the “second”, are used to distinguish one element from the other element, and the range of right of the present disclosure should not be restricted by the terms. For example, a first element may be named a second element. Likewise, a second element may be named a first element.

When it is said that one element is described as being “connected” to the other element, the one element may be directly connected to the other element, but it should be understood that a third element may be interposed between the two elements. In contrast, when it is described that one element is described as being “directly connected” to the other element, it should be understood that a third element is not interposed between the two elements. Meanwhile, the same principle applies to other expressions, such as “between ^{˜}” and “just between ^{˜}” or “adjacent to ^{˜}” and “adjacent just to ^{˜}”, which describe a relation between elements.

An expression of the singular number should be understood to include plural expressions, unless clearly expressed otherwise in the context. The terms, such as “include” or “have”, should be understood to indicate the existence of a set characteristic, number, step, operation, element, part, or a combination of them and not to exclude the existence of one or more other characteristics, numbers, steps, operations, elements, parts, or a combination of them or a possibility of the addition of them.

In each of steps, symbols (e.g., a, b, and c) are used for convenience of a description, and the symbols do not describe order of the steps. The steps may be performed in order different from order described in the context unless specific order is clearly described in the context. That is, the steps may be performed according to described order, may be performed substantially at the same time, or may be performed in reverse order.

All the terms used herein, including technological or scientific terms, have the same meanings as those that are typically understood by those skilled in the art, unless otherwise defined. Terms, such as ones defined in common dictionaries, should be construed as having the same meanings as those in the context of related technology and should not be construed as having ideal or excessively formal meanings, unless clearly defined in the specification.

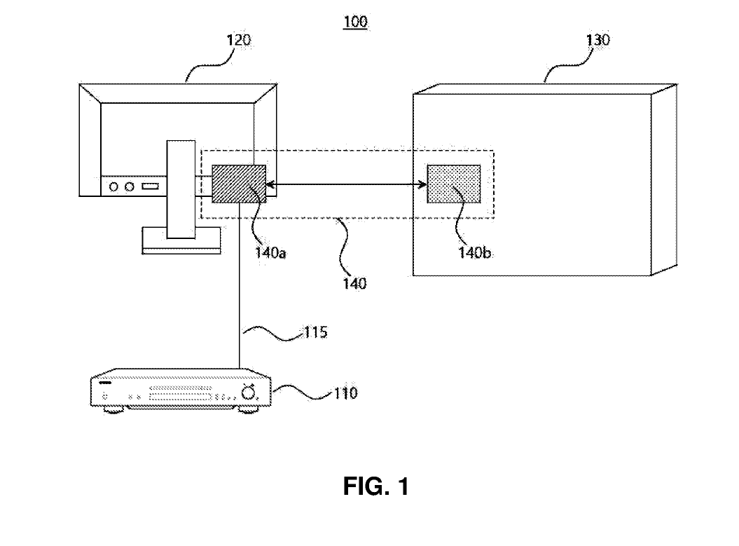

FIG. 1 is a diagram illustrating a multi-display control system according to an embodiment of the present disclosure.

Referring to FIG. 1, the multi-display control system 100 may include a set top box 110, a first display device 120, a second display device 130, and a multi-display control system 140, and these components may be connected over a network or electrically.

The set-top box corresponds to a computing device that is capable of transmitting and receiving broadcast and other contents and playing received contents. For example, the set-top box 110 may be implemented as a set top box (STB) which is a digital satellite-broadcast receiver, or may be implemented as a desktop, a laptop, a tablet PC, or a smart phone. The set top box 110 may receive a broadcast signal from a broadcast base station or from a VoD content server run by a Video on Demand (VoD) operator, and may be connected to the multi-display control device 140 or the first display device through a cable 115 which is a medium for receiving broadcast content.

The first display device 120 may be an image output device, and may be connected to the multi-display control device 140 or the set top box 110 through the cable 115 to visually display a digital signal received from the multi-display control device 140 or the set top box 110. For example, the first display device 120 may be implemented as a television or a monitor. The first display device 120 may include a cable input terminal formed at one end thereof. For example, the first display device 120 may be directly connected to the multi-display control device 140 through a cable input terminal formed at a rear surface of the first display device 120 so as to receive a duplicated broadcast signal from the multi-display control device 140, or may be directly connected to the cable 115, which is drawn from the set top box 110 and implemented as a coaxial cable, so as to receive a broadcast signal from the set top box 110.

The second display device 130 may be an image output device and may be connected to the multi-display control device 140 to visually display a broadcast signal from the multi-display control device 140. In one embodiment, the second display device 130 may correspond to a digital signage device that embeds broadcast content based on a received broadcast signal. For example, the second display device 130 may correspond to an image output device capable of being used as a digital signage device, and the second display device 130 may be implemented as an outdoor digital signage device such as a media facade which utilizes a waterproof large TV, an electronic display or a whole building as a large display, and may be implemented as an indoor digital signage device such as a monitor including a touch screen Kiosk.

The multi-display control device 140 may be connected to the set top box 10 through the cable 115 which is a medium for receiving broadcast content, and may receive a broadcast signal from the set top box 110. In one embodiment, the cable 115 may correspond to a coaxial cable used for transmission of a high frequency. In another embodiment, the cable 115 may correspond to a High Definition Multimedia Interface (HDMI) cable supporting an uncompressed-type digital video and audio interface standard. The multi-display control device 140 may be directly connected to a cable input terminal of each of the first display device 120 and the second display device 130, and may duplicate a broadcast signal received from the set top box 110 through the cable 115 into first and second broadcast signals, immediately provide the first signal to the first display device, and process and transmit the second broadcast signal to the second display device 130.

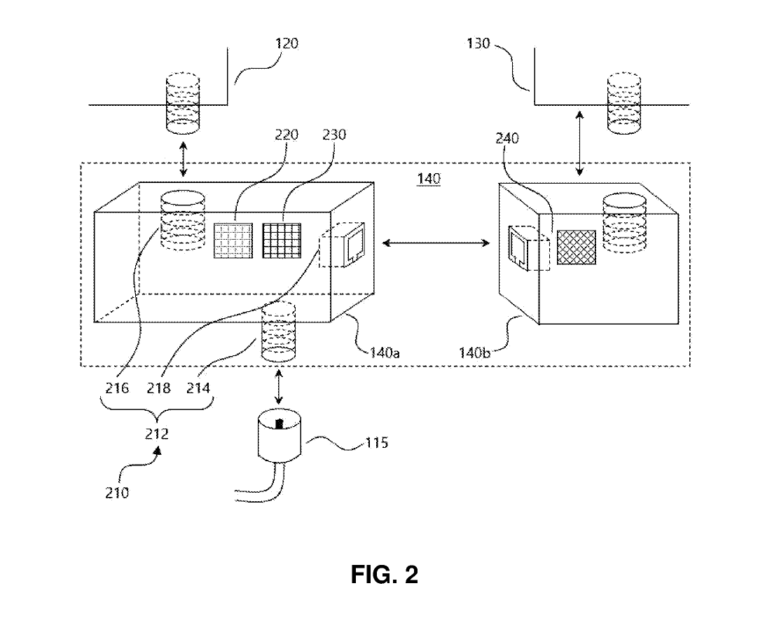

FIG. 2 is a diagram illustrating the multi-display control device shown in FIG. 1.

Referring to FIG. 2, the multi-display control device 140 may include a broadcast signal splitter 210, a buffer 220, a transmitter 230, and a broadcast signal provision unit 240, and these components may be connected electrically or over a network.

In one embodiment, the multi-display control device 140 includes one part 140a and the other part 140b: specifically, one part 140a includes the broadcast signal splitter 210, the buffer 220, and the transmitter 230 which are electrically connected to each other, and the other part 140b includes the broadcast signal provision unit 240.

The broadcast signal splitter 210 may be connected to the cable 115, and receive a broadcast signal through the cable 115. More specifically, the broadcast signal splitter 210 may be directly connected to the cable 115, and may receive a broadcast signal from the set top box 110 through the cable 115 which is drawn from the set top box 110 and directly connected to the set top box 110.

The broadcast signal splitter 210 may duplicate a broadcast signal received through the cable 115 into first and second signals. In one embodiment, the broadcast signal splitter 210 may be implemented as a splitter and may duplicate a broadcast signal from the set top box 110 into first and second signals and distribute the first and second signals to two separate receiving devices at the same time.

In one embodiment, the broadcast signal splitter 210 may immediately provide the first broadcast signal as a wired input to the first display device 120 and transmit the second broadcast signal to the buffer 220 electrically connected to the broadcast signal splitter 210. In one embodiment, the broadcast signal splitter 210 may be directly connected to a cable input terminal of the first display device 120.

The broadcast signal splitter 210 may include an integrated port switch 212. In one embodiment, the integrated port switch 212 may enable accommodation of the cable 115 from a first direction, and enable connection of the cable 115 to an input terminal of the first display device 120. In one embodiment, the integrated port switch 212 may enable wired connection of the broadcast signal provision unit 240 to the input terminal of the first display device 120 in a second direction. The first and second directions may be identical or different.

In another embodiment, the integrated port switch 212 may enable accommodation of the cable 115 from a first direction, connection of the cable 115 to an input terminal of the first display device 120 in a second direction, and wired connection of the cable 115 to an input terminal of the broadcast signal provision unit 240 in a third direction. The first, second, and third direction may be all different.

The integrated port switch 212 may include a male screw thread 214 for accommodation of the cable 115, and a female screw thread 216 for connection to an input terminal of the first display device 120. In one embodiment, the male screw thread 214 may be a coaxial cable in a male screw which outwardly protrudes so as to be connected to one side end of the cable 115, which is in the form of a female screw, and the female screw thread 216 may be a female screw which is inwardly recessed so as to be connected to an input terminal of the first display device, which is in the form of a male screw.

In one embodiment, the integrated port switch 212 may further include a cable output terminal 218 for wired connection to an input terminal of the broadcast signal provision unit 240. For example, the cable output terminal 218 may be connected to one end of a Local Area Network (LAN) cable and may be electrically connected to the broadcast signal provision unit 240 connected to the other end of the LAN cable. In one embodiment, the cable output terminal 218 may be implemented as a connector that is enabled to accommodate the one end of the LAN cable.

The buffer 22 may buffer a second broadcast signal More specifically, the buffer 220 may be electrically connected to the broadcast signal splitter 210 and the transmitter 230, and may receive the second broadcast signal from the broadcast signal splitter 210 and temporarily store the second broadcast signal in a memory included in the buffer 220 for a predetermined period of time. In one embodiment, in order to compensate for a difference in speed of transmission of the second broadcast signal by the transmitter 230 to the second display device 130, the buffer 220 may temporarily store data in a memory space included in the buffer 220, thereby enhancing a data processing capacity between the multi-display control device 140 and the second display device 130.

The transmitting unit 230 may transmit a duplicated second broadcast signal to the broadcast signal provision unit 240. In one embodiment, if at least part of the duplicated broadcast signal is buffered by the buffer 220 for a predetermined period of time, the transmitter 230 may transmit the buffered second broadcast signal to the broadcast signal provision unit 240. In another embodiment, once at least part of the duplicated second broadcast signal is buffered by the buffer 220, the transmitter 230 may immediately transmit the buffered part of the duplicated second broadcast signal to the broadcast signal provision unit 240.

The transmitter 230 may transmit the duplicated second broadcast signal to the broadcast signal provision unit 240 over Ethernet or Wi-Fi (Wireless LAN (WLAN).

In one embodiment, the transmitter 230 may transmit a second broadcast signal, temporarily stored in the buffer 220, to the broadcast signal provision unit 240 using the cable output terminal 218 of the integrated port switch 212 over Ethernet short-ranged communication. For example, the transmitter 230 utilizes a Carrier Sense Multiple Access with Collision Detection (CSMA/CD) technique of checking whether or not a communication network of a data transmitting computing device is being used, and, if it is not occupied, transmitting data. In this case, if the communication network is being used, the transmitter 230 may check again after waiting for a predetermined period of time, and then transmit a second broadcast signal to the broadcast signal provision unit 240.

In another embodiment, the transmitter 230 may transmit a second broadcast signal, temporarily stored in the buffer 220, over a wireless network including Wi-Fi and WLAN. In this case, the transmitter 230 does not use the cable output terminal 218 to transmit the second broadcast signal. In one embodiment, if necessary, the integrated port switch 212 is configured without the cable output terminal 218 so as to minimize the size of the multi-display control apparatus 140.

The transmitter 230 may perform digital encoding of a duplicated second broadcast signal based on a state of transmission to the second display device 130, and transmit digital encoded data to the broadcast signal provision unit 240 over Ethernet or Wi-Fi. In one embodiment, the transmitter 230 may constantly measure, at a predetermined time interval, a data transmission rate of a second broadcast signal transmitted from the broadcast signal provision unit 240 to the second display device 130. In one embodiment, if the data transmission rate of the second broadcast signal is less than a predetermined value, the transmitter 230 may help improve a transmission rate by encoding the second broadcast signal with a compression method having a high compression loss rate (which is, for example, equal to or greater than a specific value). If the data transmission rate of the second broadcast signal is equal to or greater than the predetermined value, the transmitter 230 may help maintaining data transmission quality at a decent level by encoding data with a conversion method having a very low compression loss rate (which is, for example, less than a specific value) conversion method. In one embodiment, data on which digital encoding has been performed by the transmitter 230 may be implemented as a binary image including a head and a body, and the head may include significant information of a corresponding broadcast signal and information on an implemented conversion method.

The broadcast signal provision unit 240 may be connected to the transmitter 230 over a network or may be electrically connected to the cable output terminal 218 through a LAN cable directly connected thereto. The broadcast signal provision unit 240 may receive a second broadcast signal from the transmitter 230 or the cable output terminal 218, and provide the second broadcast signal as an input to the second display device 130.

The broadcast signal provision unit 240 may receive encoded data and decode the encoded data. In one embodiment, the broadcast signal provision unit 240 may receive encoded data of a second broadcast signal, on which digital encoding has been performed by the transmitter 230, and decode the whole encoded data based on the information on an implemented conversion method, which is contained in a header of the encoded data.

The broadcast signal provision unit 240 may provide decoded data as an input to the second display device 130. In one embodiment the broadcast signal provision unit 240 may be directly connected to an input terminal of the second display device 130, and may include a female screw thread for connection to an input terminal of the second display device 130. More specifically, the broadcast signal provision unit 240 may include a female screw so as to be connected to the input terminal of the second display device 130, which is in the form of a male screw. In another embodiment, the broadcast signal provision unit 240 may include an input/output port enabled to be connected to the input terminal of the second display device 130 corresponding to a digital signage device, and may be wired-connected to the input terminal of the second display device 130 through a cable connecting the both ends.

The broadcast signal provision unit 240 may detect a delay tolerance, which is set in the second display device 130, and determine a degree of buffering of a second broadcast signal. More specifically, if a delay tolerance set in the second display device 130 is equal to or greater than a reference value, the broadcast signal provision unit 240 may request the buffer 220 or the transmitter 230 to increase a degree of buffering of the second broadcast signal, so that the buffer 220 temporarily stores the second broadcast signal as much as at least specific data size and the transmitter 230 transmits the temporarily stored second broadcast signal to the second display device 130. In contrast, if the delay tolerance set in the second display device 130 is equal to or less than the reference value, the broadcast signal provision unit 240 may request the buffer 220 or the transmitter 230 to reduce a degree of buffering of the second broadcast signal.

If a state of transmission to the second display device 130 is equal to or less than a specific level, the broadcast signal provision unit 240 may reduce a quality of a second broadcast signal. In one embodiment, if a delay tolerance is close to real-time playback and the transmission state is equal to or less than the specific level, the broadcast signal provision unit 240 may reduce a quality of the second broadcast signal to the minimum. More specifically, if a data transmission rate of the second broadcast signal is equal to or less than a predetermined value even when it is determined that a delay tolerance set in the second display device 130 is has a very low value close to real-time playback , the broadcast signal provision unit 240 may request the transmitter 230 to encode the buffered second broadcast signal with a conversion method having the maximum compression loss rate so as to reduce a quality of the second broadcast signal, thereby improving a transmission rate of the second broadcast signal as much as possible.

In the case when the quality of the second broadcast signal is reduced, the broadcast signal provision unit 240 may recover the quality of the second broadcast signal in stages whenever the transmission state is recovered. In one embodiment, in the case where the transmission signal provision unit 240 requests the transmitter 230 to reduce the quality of the second broadcast signal to the minimum due to a poor transmission state, the broadcast signal provision unit 240 may constantly measure a data transmission rate of the second broadcast signal at a predetermined time interval. In this case, if the data transmission rate is equal to or less than the predetermined value but recovered than before, the broadcast signal provision unit 240 may request the transmitter 230 to encode the second broadcast signal with a conversion method having a compression loss rate which is lower than that of the previously-used conversion method. A series of steps for changing an encoding method depending on recovery of a transmission state may be performed repeatedly, and, if the data transmission rate is recovered to the predetermined value or more, the broadcast signal provision unit 240 may request to encode the second broadcast signal using a conversion method having a compression loss rate of nearly 0% so as to recover the quality of the second broadcast signal, which is able to be output in the second display device, in stages.

If the delay tolerance is close to non-real-time playback and the transmission state is equal to or less than the specific level, the broadcast signal provision unit 240 may set a degree of buffering to the maximum allowable buffering of the second display device 130. In one embodiment, if the most recently measured data transmission rate of the second broadcast signal is equal to or less than the predetermined value even when it is determined that a delay tolerance set in the second display device 130 has a very high value close to a non-real-time playback, the broadcast signal provision unit 240 may request the transmitter 230 to increase the degree of buffering of the second signal to the maximum allowable buffering, and accordingly, the buffer 220 may temporarily store the second broadcast signal as much as the maximum allowable buffering and then transmit the temporarily stored second broadcast signal to the broadcast signal provision unit 240. In one embodiment, if the transmission state is equal to or less than the specific level even after adjustment of the degree of buffering, the broadcast signal provision unit 240 may reduce the quality of the second broadcast signal to the minimum.

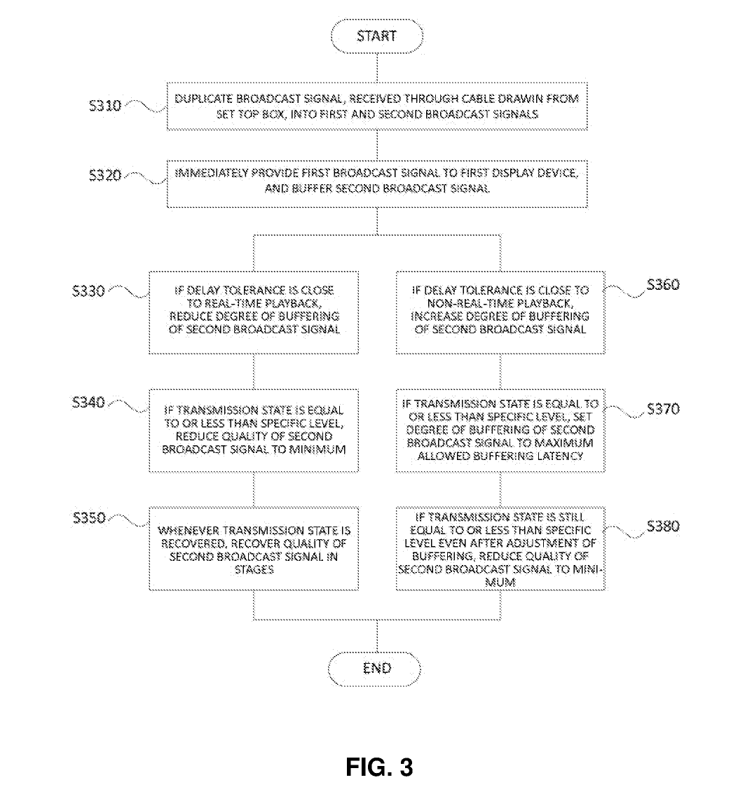

FIG. 3 is a flowchart illustrating how the multi-display control apparatus shown in FIG. 1 controls transmitting of broadcast content to a plurality of displays.

In FIG. 3, the multi-display control apparatus 140 may control transmitting of broadcast content to a plurality of displays in the following steps.

Being connected to the cable 115 drawn from the set top box 110, the broadcast signal splitter 210 may receive a broadcast signal and duplicate the received broadcast signal into first and second broadcast signals in S310.

The broadcast signal splitter 210 may immediately provide the first broadcast signal as a wired input to the first display device 120, and provide the second broadcast signal to the buffer 220 which is electrically connected to the broadcast signal splitter 210 in S320. The buffer may receive the second broadcast signal from the broadcast signal splitter 210 and buffer the second broadcast signal in a memory space included in the buffer 220 for a predetermined period of time.

The transmitter 230 may perform digital encoding of the buffered second broadcast signal based on a state of transmission to the second display device 130, and transmit digital encoded data to the broadcast signal provision unit 240 over Ethernet or Wi-Fi. The broadcast signal provision unit 240 may be connected to an input terminal of the second display device 130, and may provide decoded data, received from the transmitter, as an input to the second display device 130.

The above-described steps may be repeatedly performed in a procedure of providing duplicated broadcast signals to the first and second display devices 120 and 130. In such a procedure, the broadcast signal provision unit 240 may detect a delay tolerance set in the second display device 130, and control a degree of buffering of the second broadcast signal based on a state of transmission to the second display device 130.

If it is determined that the delay tolerance is equal to or less than a reference value and has a low value close to real-time playback, the broadcast signal provision unit 240 may request the buffer 220 or the transmitter 230 to reduce a degree of buffering of the second broadcast signal in S330. In this case, if the state of transmission to the second display device 130 is equal to or less than a specific level, the broadcast signal provision unit 240 may reduce a quality of the second broadcast to the minimum in S340. Then, the broadcast signal provision unit 240 may recover the quality of the second broadcast signal whenever the transmission state is recovered in stages in S350.

If it is determined that the delay tolerance is equal to or greater than the reference value and has a high value close to non-real-time playback, the broadcast signal provision unit 240 may request to increase a degree of buffering of the second broadcast signal in S360. In this case, if a state of transmission to the second display device 130 is equal to or less than a specific level, the broadcast signal provision unit 240 may request the buffer 220 or the transmitter 230 to set a degree of buffering of the second broadcast signal to the maximum allowable buffering in S370. If the transmission state is still determined to be equal to or less than the specific level even after adjustment of the degree of buffering, the broadcast signal provision unit 240 may reduce a quality of the second broadcast signal to the minimum in S380.

In one embodiment, by duplicating a signal, received from the cable 115 in the above-described steps, the multi-display control apparatus 140 may immediately provide a second broadcast signal as a wired input to the first display device 120 and may control a quality of the second broadcast signal and a degree of buffering of the second broadcast signal based on a transmission state of a broadcast signal to the second display device 130. Accordingly, the multi-display control apparatus 140 may efficiently provide broadcast signals to a plurality of displays.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept.

What is claimed is:

1. A multi-display control apparatus comprising:
a broadcast signal splitter connected to a cable, which is a medium for receiving broadcast content, and configured to duplicate a broadcast signal received through the cable into first and second broadcast signals and immediately provide the first broadcast signal to a first display device;
a buffer configured to buffer the second broadcast signal;
a transmitter configured to perform digital encoding of the duplicated second broadcast signal based on a state of transmission to a second display device, and transmit the encoded data over Ethernet or Wi-Fi;
a broadcast signal provision unit configured to receive and decode the encoded data, and provide the decoded data as an input to the second display device.

2. The multi-display control apparatus of claim 1, wherein the broadcast signal splitter receives the broadcast signal through the cable drawn from a set top box, and is connected to a cable input terminal of the first display device.

3. The multi-display control apparatus of claim 1, wherein the broadcast signal splitter comprises an integrated port switch that enables accommodation of the cable from a first direction, connection to an input terminal of the first display device, and wired connection to an input terminal of the broadcast signal provision unit in a second direction.

4. The multi-display control apparatus of claim 3, wherein the integrated port switch comprises:
a male screw thread for accommodation of the cable;
a female screw thread for connection to an input terminal of the first display device; and
a cable output terminal for wired connection to the input terminal of the broadcast signal provision unit.

5. The multi-display control apparatus of claim 1, wherein the broadcast signal provision unit detects a delay tolerance set in the second display device and determines a degree of buffering of the second broadcast signal.

6. The multi-display control apparatus of claim 5, wherein, when the delay tolerance is close to real-time playback and the transmission state is equal to or less than a specific level, the broadcast signal provision unit reduces a quality of the second broadcast signal to a minimum.

7. The multi-display control apparatus of claim 6, wherein the broadcast provision unit recovers the quality of the second broadcast signal in stages whenever the transmission state of is recovered.

8. The multi-display control apparatus of claim 5, wherein, when the delay tolerance is close to non-real-time playback and the transmission state is equal to or less than a specific level, the broadcast signal provision unit sets the degree of buffering to a maximum allowable buffering for the second display device.

9. The multi-display control apparatus of claim 8, wherein, when the transmission state is equal or less than the specific level even after adjustment of the degree of buffering, the broadcast signal provision unit reduces a quality of the second broadcast signal to a minimum.

10. The multi-display control apparatus of claim 1, wherein the second display apparatus corresponds to a digital signage device that embeds broadcast content based on the second broadcast signal.

11. A multi-display control method implemented by a multi-display control apparatus which is connected to first and second display devices and a cable, which is a medium of receiving broadcast contents, the method comprising:
a broadcast signal splitting step of duplicating a broadcast signal received through the cable into first and second broadcast signals and immediately providing the first broadcast signal as a wired input to the first display device;
a buffering step of buffering the second broadcast signal;
a transmitting step of performing digital encoding of the duplicated second broadcast signal based on a state of transmission to the second display device, and of transmitting the encoded data over Ethernet or Wi-Fi; and
a broadcast signal providing step of receiving and decoding the encoded data, and of providing the decoded data as an input to the second display device.

12. The multi-display control method of claim 11, wherein the broadcast signal provision step comprises a step of detecting a delay tolerance set in the second display device and determining a degree of buffering of the second broadcast signal.

13. The multi-display control apparatus of claim 12, wherein the broadcast signal providing step comprises a step of, when the delay tolerance is close to real-time playback and the transmission state is equal to or less than a specific level, reducing a quality of the second broadcast signal to a minimum.

14. The multi-display control method of claim 12, wherein the broadcast signal providing step comprises a step of, when the delay tolerance is close to a non-real-time playback and the transmission state is equal to or less than a specific level, setting the degree of buffering to a maximum allowable buffering of the second display device.
